(19) United States
(12) Patent Application Publication
(10) Pub. No.: US 2014/0367303 A1
(43) Pub. Date: Dec. 18, 2014

(54) Edible Gift Personalizable With Sound

(71) Applicants: Mark Wertman, Marlboro, NJ (US); Sarah Wertman, Marlboro, NJ (US)

(72) Inventors: Mark Wertman, Marlboro, NJ (US); Sarah Wertman, Marlboro, NJ (US)

(21) Appl. No.: 14/224,994

(22) Filed: Mar. 25, 2014

Related U.S. Application Data
(60) Provisional application No. 61/836,458, filed on Jun. 18, 2013.

(51) Int. Cl. A21D 13/00; B65B 5/04; A47J 47/14; A23P 1/00

(52) U.S. Cl. CPC A21D 13/009; A23P 1/005; B65B 5/04; A47J 47/14
USPC 206/551; 426/132; 53/473; 206/771

(57) ABSTRACT

A sound module is positioned in an edible structure such that the gift remains intact when constructed and transported, appetizing to perceive, and safe for consumption. The sound module is sealed into the structure using an edible adhesive that is strong enough to hold the module in place without deleterious effects to the structure of the gift. The sound module remains artfully concealed yet still audible, as well as accessible to be operated.

### CROSS REFERENCE TO RELATED APPLICATION

This application claims the benefit of priority of U.S. Provisional Application 61/836,458.

### BACKGROUND OF THE INVENTION

1. Field of the Invention

The present invention relates to food products and to personalized gifts.

2. Description of the Related Art

Food has long been associated with giving. Personalization of food adds an extra layer of panache and is common in forms such as baskets of fruit or lollipops with cards poking through the cornucopia, or cakes and cookies with icing writing. Edibles that express sentiments, such as birthday candles in the shape of numbers, or gummy candy lettering, have likewise long been known. Personalized edible gifts are used for marketing, as in a tin of mints carrying a corporate logo. Personalized food is common at wedding celebrations, in the form of favors commemorating bride and groom, and of course, the wedding cake, topped with rendering of the happy pair.

All gifts can be seen as personalized, picked out specifically for the recipient by the giver. In recent times an industry has grown up around the creation of gifts that are personalized with special messages for the recipient. Distances are bridged by lovers sending flowers that are delivered with a personalized note, or with calendars, mugs or picture frames helping retirees see their grandchildren year round.

There are also variations of personalized gifts based on sound and music, from a mixtape created for a best friend to a greeting card that plays a tune when opened. In personalized home decor, one's voice may be recorded and transformed into a large format canvas print of its sound waves. A happy birthday voice mail or a singing telegram is the grandparent of gifts such as the teddy bear with a personalized voice message. Voice modules such as that used in the singing teddy may be purchased off the shelf and are currently activated by sliding switch (as in greeting cards), light sensor, or touch.

While personalized voice messages in gifts are desirable, they are not associated with edibles. The addition of electronics such as voice modules is hindered by the material properties of food, which may be brittle, crumbly, meltable, and more importantly by the risk of contamination with food-borne disease.

### SUMMARY OF THE INVENTION

The present invention is a personalizable gift that is edible yet has the magic of sound. A sound module is positioned in an edible structure such that the gift remains intact when constructed and transported, appetizing to look at, and safe for consumption. The sound module is sealed into the structure using an edible adhesive that is strong enough to hold the module in place without deleterious effects to the structure of the gift. The edible gift may take many shapes and sculptural forms, and in a preferred embodiment the sound module remains artfully concealed yet still audible. One example would be a chocolate grand piano, its lid propped open, the sound module embedded in its base.

In the preferred embodiment, the invention uses a touch-activated sound module, so that the module is operable as desired by the recipient. The touch-activated sound module, while remaining artfully concealed, must also remain accessible. The chocolate grand piano is a good example demonstrating both hiddenness and accessiblity, for the sound module is hidden in its base and a recipient need only reach under the piano's legs to activate the module. After the piano is consumed, the sound module may be retained by the recipient as a keepsake.

Safe transport is achieved by packaging the invention in a container to which the edible gift has been stably affixed, so that it remains intact during transport and arrives safe and good to eat.

### DESCRIPTION OF THE DRAWINGS

In the following drawings, which form a part of the specification and are to be construed in conjunction therewith, like reference numerals have been employed throughout wherever possible to indicate like parts in the various views:

FIG. 1 is a full view of a chocolate piano edible gift with personalizable sound module.

FIG. 2 is a close-up view of a personalizable sound module.

FIG. 3 is a close-up view of the sound module fixed into a wall of the edible structure.

FIG. 4A is a view of the sound module set into a donut using a sound module anchor.

FIG. 4B is an alternative embodiment of a sound module anchor.

FIG. 5A is a full view of a package for an edible gift.

FIG. 5B is a close-up and deconstructed view of the apparatus that secures the edible gift in the package.

### DETAILED DESCRIPTION OF THE INVENTION

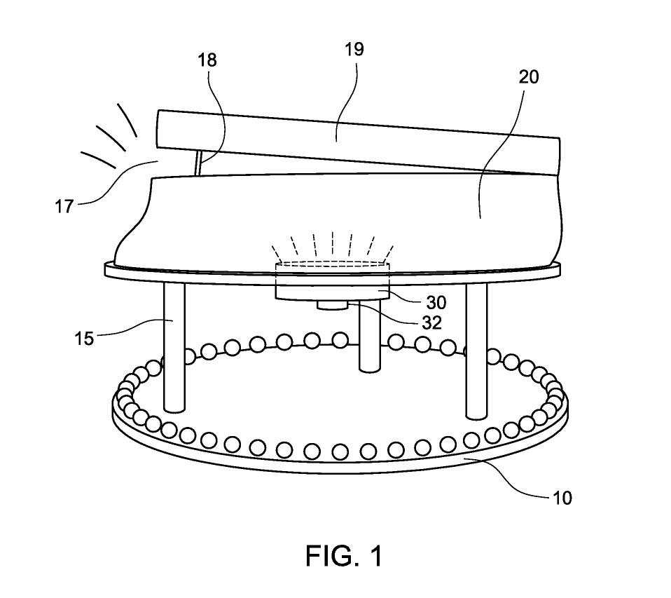

FIG. 1 is a full view of one embodiment of the edible gift of the present invention. In this embodiment, sound module 30 has been safely sealed into the base of a white chocolate piano 20. The entire piano is edible. The sound module 30 is touch activated and positioned in the piano to be audible and accessible to activate. The sound module has been made safe to touch food and sealed into the base of the piano using white chocolate, which when melted acts as an adhesive to surrounding chocolate.

In the example depicted in FIG. 1, the sound module has been artfully placed in the base of the piano, with the speaker of the sound module facing upwards, and the lid 19 has been propped open (by an edible dowel 18) thus allowing sound to freely emit. The sound module is activated by a button 32, which is easily accessible under the base of the piano. Other sculptural forms and structures are possible, such as a champagne bottle, items of clothing such as shoes and dresses, TV characters, a wedding cake, etc. . . . As with the piano, legs may be used to elevate a shape, allowing the sound module to be positioned to be accessible. For instance, the edible structure may comprise a heart-shaped box with lid positioned ajar to allow for sound to emit, and legs to elevate the sculptural aspect of the structure and to allow the sound module to be easily touched and activated. The invention lies not in the shape of the gift but in the manner in which the sound module has been stably and safely sealed into its walls.

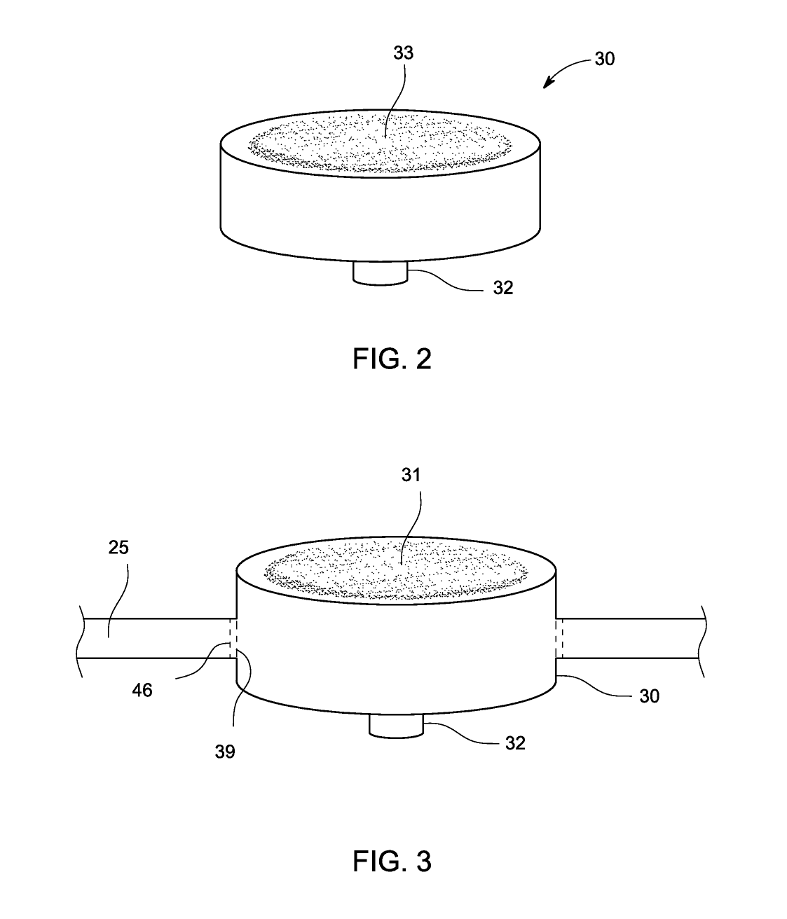

A closer view of sound module 30 is depicted in FIG. 2, the depicted module comprising a speaker portion 33 and a touch activation 32. In this example, the touch activation is a button that can be pressed to play a sound. The sound module is large enough so as not to be a choking hazard, and it is kept safe to touch food throughout assembly of the gift. Food safety may be achieved and maintained by cleaning the module and using an edible and food safe adhesive to seal it into the structure, by covering it in a material that is safe to touch food, including a food safe plastic or paper, or it is even contemplated that a fully food safe sound module may one day be available. The sound module may be pre-recorded with a personalized message before assembling into the gift, or it may be recordable by the consumer.

Referring to FIG. 3, an opening 39 into which the sound module will fit is cut into wall 25 of the edible structure, and sound module 30 is sealed within the wall using an edible adhesive. Chocolate is a preferred adhesive in the case of a chocolate structure, because it blends aesthetically with the structure, and when fused against chocolate, is strong enough to hold the sound module stably in place, that is, until the gift is consumed. Chocolate is formable and operable as an adhesive at 105 to 110 degrees Fahrenheit, and will set in place as it cools. Once the structure of the gift has been created, the structure is cooled to room temperature of 60 to 67 degrees before the sound module is sealed within. Other examples of edible adhesives are known in the art, including edible glue, edible plastic spray, and frosting.

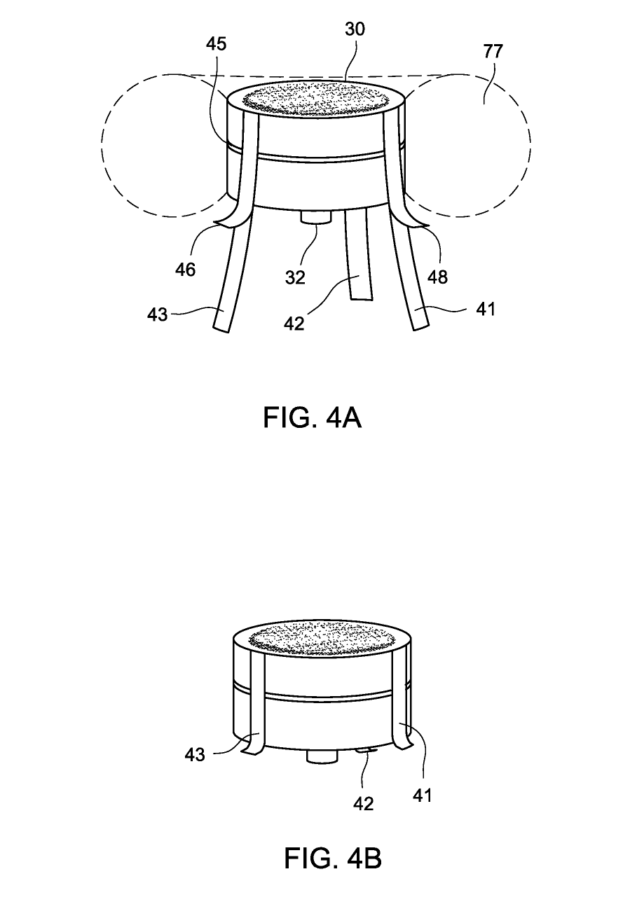

In another embodiment, the sound module may be set into an anchor that facilitates easy insertion into many edible materials, is safe to touch food, and provides added stability. FIG. 4A depicts such an anchor set into the hole of a donut 77, where the anchor comprises legs 41-43 and band 45 connecting the legs. One purpose of the band is to provide stability for the anchor, and as such may be around the outside of the legs, or may reach across the legs from under the sound module. The legs 41-43 facilitate access to the activation button 32 of sound module 30. The legs may also provide support to an edible object or sculpture by further comprising one or more lips 46-48 upon which the edible object or sculpture may rest. The anchor comprises a material that is safe to touch food. In the case of an edible object or sculpture in which elevation is not needed, FIG. 4B depicts another embodiment of an anchor having only the lips 41-43, which allow the sound module to be set firmly in place in any edible structure. The anchor may be combined with an edible adhesive for added stability. Through use of the anchor, the sound module may be adapted to many foods, and also is easy to package and ship. Using the anchor, the sound module may be inserted into a wide variety of edible structures, including donuts, cakes, cookies, and gingerbread houses.

Once the shape of the edible structure has been designed and its constituent parts produced, the steps necessary to create the personalized or personalizable gift are as follows: an appropriately sized opening is cut into the structure, into which the sound module 30 will fit. The sound module may be left for a user to record, or the method may comprise the additional step of recording a personalized message. The sound module may be safe to touch food, or the method may comprise the extra step of making the sound module safe to touch food, such as by covering it in food safe material including food safe paper or plastic. An edible adhesive is then used to fix the sound module into the opening so that both the speaker of the sound module and its activation means are exposed. The entire gift structure may be assembled in whatever order is optimal as would be understood by one skilled in the art. For instance, the personalizable sound module may be fixed into a sculpture first, the sculpture mounted on legs second, and the legs sealed to an edible base last.

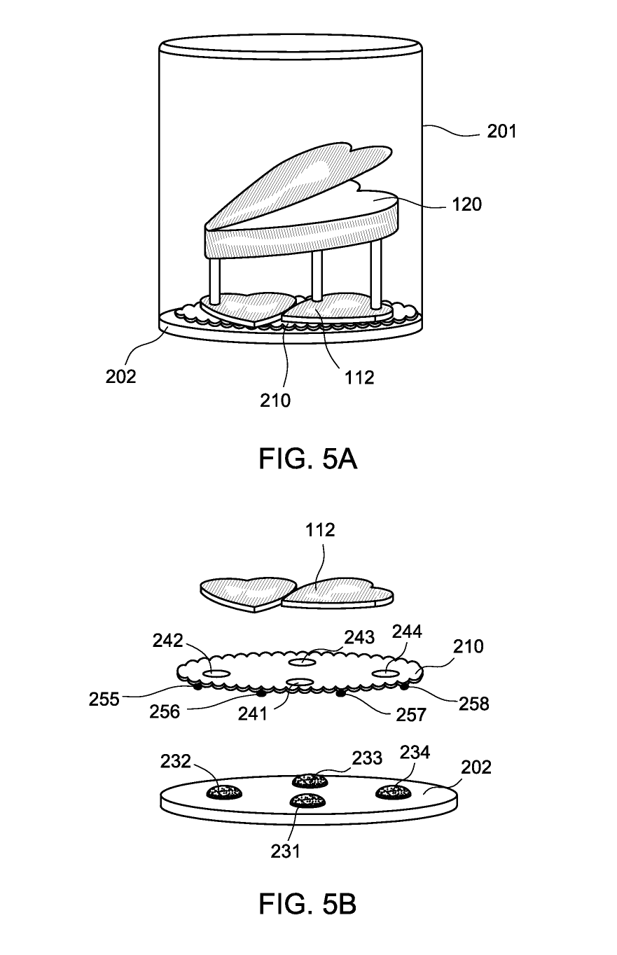

It will be desirable to package the edible gift in a container for presentation and safe transport. FIG. 5A is a full view showing an edible gift 120 in such a container. The edible gift 120 rests atop edible base 112, which is secured to the container base 202 in the matter that will be described below. The edible gift shown in FIG. 5A is in the figure of a heart-shaped box raised on three legs and mounted on an edible base of overlapping hearts, but the structure and its base may take any form or shape. As shown in blown-up view FIG. 5B, one or more dollops 231-234 of edible adhesive are deposited onto container base 202, over which is positioned a base panel 210 having one or more openings 241-244 through which the dollops of edible adhesive may pass. The base panel may be decorative, as in the example shown in FIG. 5B, or it may be functional. A supertacky adhesive is placed on the underside of base panel 210, such as in spots 255-258, to firmly secure the base panel to the container base 202. An adhesive that is supertacky, and which may be edible, non-edible, or safe to be near food, is preferred because it firmly secures the base panel to the container base. As the base panel 210 is secured to the container base 202, the dollops of edible adhesive 231-234 pass through the openings 241-244 of the panel, and when the edible base 112 is placed on top, the structure becomes securely fixed to the container base via the edible adhesive that has oozed through the openings 241-244. In this manner the personalizable gift is secured stably to the container base without the propensity to dislodge or break. A cover 201 may then be placed atop the container base 202 for secure transport.

What is claimed is:

1. A personalizable gift comprising an edible structure and a sound module fixed with an edible adhesive into a wall of the edible structure.

2. The personalizable gift of claim 1 wherein the sound module is pre-recorded or recordable.

3. The personalizable gift of claim 1 wherein the sound module is touch activated.

4. The personalizable gift of claim 1 wherein the sound module is safe to touch food.

5. The personalizable gift of claim 1 wherein the edible structure allows the sound module to be audible.

6. The personalizable gift of claim 1 wherein the edible structure allows the sound module to be accessible to be activated.

7. The personalizable gift of claim 1 further comprising an anchor for setting the sound module into the wall of the edible structure.

8. The personalizable gift of claim 7 wherein the anchor comprises a lip.

9. The personalizable gift of claim 7 wherein the anchor comprises one or more legs to elevate the sound module.

10. A method for creating the personalizable gift of claim 1 comprising the steps of (a) creating an opening in the wall of the edible structure; and (b) fixing the sound module into the opening with the edible adhesive.

11. The method of claim 10 comprising the additional step of recording a personalized message onto the sound module.

12. The method of claim 10 comprising the additional step of making the sound module safe to touch food.

13. The method of claim 10 comprising the additional steps of (c) setting the sound module into an anchor and (d) placing the anchor and sound module into the opening.

14. A package for the personalizable gift of claim 1 comprising:
a container bottom; and
a base panel having one or more openings through which a second edible adhesive may pass and adhere to the edible sculpture;
wherein the base panel is secured to the container bottom by a supertacky adhesive.

15. A method for packaging the personalizable gift of claim 1 comprising the steps of:
(a) depositing one or more dollops of edible adhesive onto a base of a package;
(b) creating one or more openings in a base panel to be placed over the dollops of edible adhesive;
(c) depositing supertacky adhesive on the underside of the base panel;
(d) pressing the base panel onto the base of the package, wherein the dollops of edible adhesive pass through the one or more openings of the base panel; and
(e) setting the edible sculpture over the base panel to adhere to the dollops of edible adhesive that have passed through the one or more openings of the base panel.

16. A method for creating a personalizable gift comprising the steps of (a) creating an opening in the wall of an edible structure; and (b) fixing a sound module into the opening with an edible adhesive.

17. The method of claim 16 comprising the additional step of recording a personalized message onto the sound module.

18. The method of claim 16 comprising the additional step of making the sound module safe to touch food.

19. The method of claim 16 comprising the additional steps of (c) setting the sound module into an anchor and (d) placing the anchor and sound module into the opening.

20. A package for an edible sculpture comprising:
a container bottom; and
a base panel having one or more openings through which an edible adhesive may pass and adhere to the edible sculpture;
wherein the base panel is secured to the container bottom by a supertacky adhesive.

21. A method for packaging an edible sculpture comprising the steps of:
depositing one or more dollops of an edible adhesive onto a base of a package;
creating one or more openings in a base panel to be placed over the dollops of edible adhesive;
attaching supertacky adhesive to the underside of the base panel;
pressing the base panel onto the base of the package, wherein the dollops of edible adhesive pass through the one or more openings of the base panel; and
fixing the edible sculpture over the base panel to adhere to the dollops of edible adhesive that have passed through the one or more openings of the base panel.
